(19) United States
(12) Patent Application Publication
(10) Pub. No.: US 2026/0116198 A1
(43) Pub. Date: Apr. 30, 2026

(54) VEHICLE BATTERY PROTECTION DEVICE

(71) Applicant: TOYOTA JIDOSHA KABUSHIKI KAISHA, Toyota-shi (JP)

(72) Inventor: Seiya ISHIKURA, Toyota-shi (JP)

(73) Assignee: TOYOTA JIDOSHA KABUSHIKI KAISHA, Toyota-shi (JP)

(21) Appl. No.: 19/361,451

(22) Filed: Oct. 17, 2025

(30) Foreign Application Priority Data
Oct. 31, 2024 (JP) 2024-192230

(51) Int. Cl. B60L 3/00; B60K 1/04; B60K 25/10; B60K 31/00; B60L 15/20

(52) U.S. Cl. CPC B60L 3/0007; B60K 25/10; B60L 15/2009; B60K 2001/0438; B60K 2031/0016; B60L 2240/423

(57) ABSTRACT

A battery protection device includes a LiDAR device or a camera that detects an obstruction that is present in a direction of travel of a vehicle that includes a battery that is disposed downward from a floor of a vehicle body and an air suspension device configured to adjust a vehicle body height. Upon determining that the obstruction that is detected by the LiDAR device or the camera is likely to come into contact with the battery, a control unit controls the air suspension device and also controls MGs or a brake device to adjust a minimum ground clearance and an attitude of the vehicle body.

### CROSS-REFERENCE TO RELATED APPLICATION

This application claims priority to Japanese Patent Application No. 2024-192230 filed on Oct. 31, 2024. The disclosure of the above-identified application, including the specification, drawings, and claims, is incorporated by reference herein in its entirety.

### BACKGROUND

### 1. Technical Field

The present disclosure relates to a vehicle battery protection device.

### 2. Description of Related Art

Japanese Unexamined Patent Application Publication No. 2022-70848 (JP 2022-70848 A) discloses a battery protection member in which an inclined face and a buffer chamber are formed, and when an obstruction collides with the inclined face, the battery protection member undergoes rearward deflection and deformation, and at the same time, the buffer chamber also absorbs the impact, thereby providing double absorption of energy that is generated by the collision with the obstruction.

### SUMMARY

The technology that is described in JP 2022-70848 A is configured to protect a battery from obstructions by providing a protective member around the battery, but this increases the number of vehicle parts, which is problematic in that vehicle weight and costs increase.

The present disclosure has been made in consideration of the above circumstances, and an object thereof is to provide a vehicle battery protection device that can suppress increase in the number of vehicle parts while protecting the battery.

A vehicle battery protection device according to a first aspect includes a detecting unit that detects an obstruction present in a direction of travel of a vehicle that includes a battery that is disposed downward from a floor of a vehicle body and an active suspension device that is configured to adjust a vehicle body height, and a control unit that, when determination is made that the obstruction that is detected by the detecting unit is likely to come into contact with the battery, controls the active suspension device and also controls a drive device or a braking device of the vehicle to adjust a minimum ground clearance and an attitude of the vehicle body.

In the first aspect, when determination is made that an obstruction that is present in the direction of travel of the vehicle is likely to come into contact with the battery that is located downward from the floor of the vehicle body, the active suspension device that the vehicle is equipped with is controlled, and also the drive device or the braking device of the vehicle is controlled, in order to adjust the minimum ground clearance and the attitude of the vehicle body. Thus, according to the first aspect, adjusting the minimum ground clearance and the attitude of the vehicle body enables obstructions to be kept from coming into contact with the battery, thereby doing away with the need to provide protective materials and so forth around the battery to protect the battery, and hence suppressing increase in the number of vehicle parts.

According to a second aspect, in the first aspect, the detecting unit detects a height of an obstruction, when the obstruction that is present in the direction of travel of the vehicle is detected, and the control unit determines that there the obstruction is likely to come into contact with the battery when the height of the obstruction that is detected by the detecting unit is equal to or greater than a current minimum ground clearance of the vehicle body.

In the second aspect, the height of the obstruction is detected, and when the height of the obstruction is equal to or greater than the minimum ground clearance of the vehicle body, determination is made that the obstruction will likely come into contact with the battery. Thus, whether the obstruction will likely come into contact with the battery can be accurately determined.

According to a third aspect, in the second aspect, when the height of the obstruction that is detected by the detecting unit is less than a predetermined value, the control unit controls the active suspension device to increase the minimum ground clearance on each of a front wheel side and a rear wheel side of the vehicle, and also to increase drive torque that is applied by the drive device to rear wheels of the vehicle.

In the third aspect, the active suspension device is controlled such that the minimum ground clearances on the front wheel side and the rear wheel side of the vehicle are each increased, and also the drive torque that is applied by the drive device to the rear wheels of the vehicle is increased. This causes the vehicle body of the vehicle to assume a rearward-tilted attitude in which the side of the vehicle in the direction of travel is higher than the opposite side of the direction of travel, thereby enabling circumvention of a situation in which the obstruction with a height of less than the predetermined value comes into contact with the battery when the obstruction passes through the space downward from the body.

According to a fourth aspect, in the second aspect, when the height of the obstruction that is detected by the detecting unit is equal to or greater than a predetermined value, the control unit controls the active suspension device to decrease the minimum ground clearance on a front wheel side of the vehicle and also to increase the minimum ground clearance on a rear wheel side of the vehicle, and also increases braking torque that is applied by the braking device to front wheels of the vehicle.

In the fourth aspect, the active suspension device is controlled such that the minimum ground clearance on the front wheel side of the vehicle is decreased and also the minimum ground clearance on the rear wheel side of the vehicle is increased, and also the braking torque that is applied by the braking device to the front wheels of the vehicle is increased. Thus, the vehicle body of the vehicle assumes a forward-tilted attitude in which the side of the vehicle in the direction of travel is lower than that on the opposite side from the direction of travel, and the obstruction with the height equal to or greater than the predetermined value collides with a member that is located at a front end portion of the vehicle in the direction of travel (e.g., bumper or the like), thereby enabling circumvention of a situation in which the obstruction enters the space downward from the vehicle body and comes into contact with the battery.

The present disclosure has an effect of suppressing an increase in the number of vehicle parts when protecting a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a battery protection device according to an embodiment;

FIG. 2 is a conceptual diagram illustrating an example of a vehicle and an obstruction;

FIG. 3 is a flowchart showing attitude and vehicle body height control processing;

FIG. 4A is a conceptual diagram illustrating a steady state;

FIG. 4B is a conceptual diagram illustrating a state in which a vehicle body is tilted backward;

FIG. 5A is a conceptual diagram illustrating the steady state; and

FIG. 5B is a conceptual diagram illustrating a state in which the vehicle body is tilted forward.

### DETAILED DESCRIPTION OF EMBODIMENTS

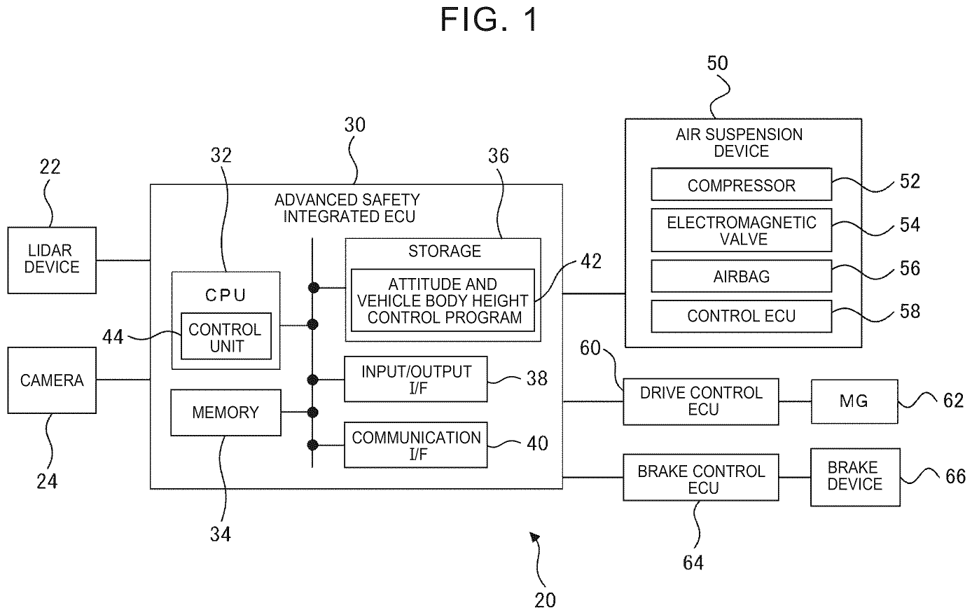

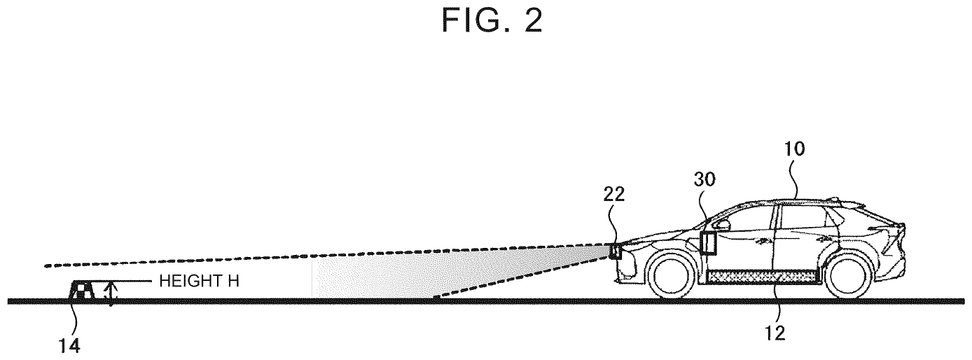

An example of an embodiment of the present disclosure will be described in detail below with reference to the drawings. FIG. 1 illustrates a battery protection device 20 according to the present embodiment. As illustrated in FIG. 2, a vehicle 10 equipped with the battery protection device 20 includes a battery 12 that serves as a driving source for a motor generator (MG) 62 and that is disposed downward from a floor of a vehicle body. The vehicle 10 may be any one of a plug-in hybrid electric vehicle (PHEV), a battery electric vehicle (BEV), or a hybrid electric vehicle (HEV).

The battery protection device 20 is a device to suppress contact between the battery 12 and an obstruction 14, and includes a Light Detection and Ranging (LiDAR) device 22 and a camera 24. The LiDAR device 22 is provided at a front end portion of the vehicle 10, and emits laser light to an area forward from the vehicle 10, and based on information regarding reflected light therefrom, detects distance, height H (see FIG. 2), and so forth, of an obstruction 14 that is present forward of the vehicle 10.

The camera 24 is made up of a stereo camera, and is provided inside of a vehicle cabin of the vehicle 10. The camera 24 performs shooting forward of the vehicle 10 and detects the distance to, and the height H of, the obstruction 14 that is present forward of the vehicle 10, based on parallax between right and left images that are obtained by shooting, and so forth. The LiDAR device 22 and the camera 24 are connected to an advanced safety integrated electronic control unit (ECU) 30, and output detection results regarding the obstruction 14 to the advanced safety integrated ECU 30. The LiDAR device 22 and the camera 24 are examples of a detecting unit according to the present disclosure.

The vehicle 10 is also provided with an air suspension device 50 that can independently adjust vehicle body height at each of four wheels, and the air suspension device 50 is connected to the advanced safety integrated ECU 30. The air suspension device 50 includes a compressor 52, electromagnetic valves 54, airbags 56, and a control ECU 58. The compressor 52 is connected to a pressure tank, and compressed air that is generated by the compressor 52 is stored in the pressure tank. Also, the airbag 56 is provided on each of the four wheels of the vehicle 10, in place of metal springs in a normal suspension. Each of the airbags 56 is connected to the pressure tank via an electromagnetic valve 54 for air supply, and is also connected to an electromagnetic valve 54 for exhaust.

When the vehicle body height (minimum ground clearance) of the vehicle 10 is to be raised, the control ECU 58 opens the electromagnetic valves 54 for air supply, which are connected to the airbags 56. Thus, the compressed air that is stored in the pressure tank flows into the airbags 56, and the overall length of the airbag 56 expands, raising the vehicle body height of the vehicle 10 and increasing the minimum ground clearance. Also, when the vehicle body height (minimum ground clearance) of the vehicle 10 is to be lowered, the control ECU 58 opens the electromagnetic valves 54 for exhaust, which are connected to the airbags 56. Thus, air is discharged from within the airbags 56, and the overall length of the airbags 56 is reduced, lowering the vehicle body height of the vehicle 10 and reducing the minimum ground clearance. The air suspension device 50 is an example of an active suspension device in the present disclosure.

Also, the advanced safety integrated ECU 30 is connected to the MG 62 via a drive control ECU 60, and is also connected to a brake device 66 via a brake control ECU 64. The MG 62 is provided for each of the wheels of the vehicle 10, and the drive control ECU 60 is capable of controlling driving of each of the MGs 62 for respective wheels of the vehicle 10. The drive control ECU 60 and the MGs 62 are an example of a drive device in the present disclosure. Also, the brake control ECU 64 is capable of separately controlling 30 braking torque that is generated by the brake device 66 for the front wheels, and for the rear wheels of the vehicle 10. The brake control ECU 64 and the brake device 66 are an example of a braking device in the present disclosure.

The advanced safety integrated ECU 30 has built therein a central processing unit (CPU) 32, memory 34 such as read-only memory (ROM) and random access memory (RAM) and so forth, storage 36 such as a hard disk drive (HDD) or a solid state drive (SSD) or the like, an input/output interface (I/F) 38, and a communication I/F 40.

An attitude and vehicle body height control program 42 is stored in the storage 36. The advanced safety integrated ECU 30 functions as a control unit 44, by the attitude and vehicle body height control program 42 being read from the storage 36 and being loaded to the memory 34, and the attitude and vehicle body height control program 42 that is loaded to the memory 34 being executed by the CPU 32. When determining that the obstruction 14 that is detected by the LiDAR device 22 or the camera 24 will likely come into contact with the battery 12, the control unit 44 controls the air suspension device 50 and also controls the drive control ECU 60 or the brake control ECU 64, so as to adjust the minimum ground clearance and the attitude of the vehicle body of the vehicle 10.

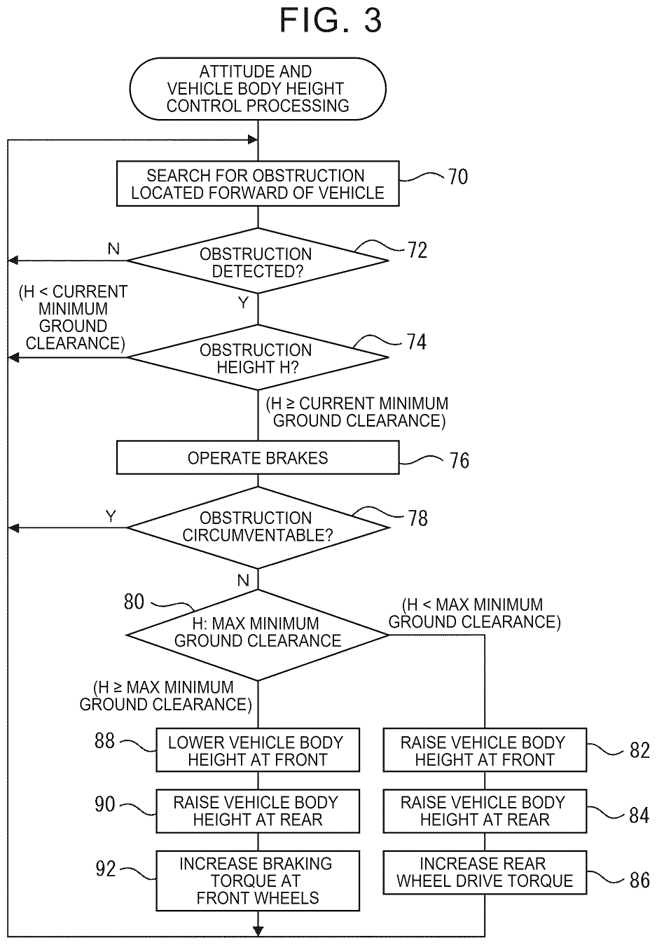

Next, as operations of the present embodiment, attitude and vehicle body height control processing that is executed by the advanced safety integrated ECU 30 (control unit 44) while an ignition switch of the vehicle 10 is on will be described with reference to FIG. 3.

In step 70 of the attitude and vehicle body height control processing, the control unit 44 causes the LiDAR device 22 or the camera 24 to search for an obstruction 14 that is present forward of the vehicle 10. In step 72, the control unit 44 determines whether an obstruction 14 that is present forward of the vehicle 10 has been detected by the LiDAR device 22 or the camera 24. When there is no obstruction 14 that is present forward of the vehicle 10, a negative determination is returned in step 72, and the processing returns to step 70.

Also, when an obstruction 14 is present forward of the vehicle 10, the determination in step 72 is affirmative and the processing transitions to step 74. In step 74, the control unit 44 acquires the height H of the obstruction 14 that is present forward of the vehicle 10 from the LiDAR device 22 or the camera 24, and determines a magnitude relation between the height H of the obstruction 14 and the current minimum ground clearance of the vehicle 10. When the height H of the obstruction 14 is lower than the current minimum ground clearance of the vehicle 10, determination is made that the obstruction 14 is unlikely to come into contact with the battery 12. Accordingly, when the height H of the obstruction 14 is lower than the current minimum ground clearance of the vehicle 10, the processing returns from step 74 to step 70.

Also, when the height H of the obstruction 14 is equal to or greater than the current minimum ground clearance of the vehicle 10, determination can be made that there is a likelihood that the obstruction 14 will come into contact with the battery 12, unless measures are taken. Accordingly, when the height H of the obstruction 14 is equal to or greater than the minimum ground clearance of the vehicle 10, the processing transitions from step 74 to step 76. Then in step 76, the control unit 44 causes the brake control ECU 64 to operate the brake device 66 so as to decelerate the vehicle 10. This improves the likelihood of circumventing collision with the obstruction 14 by being able to bring the vehicle 10 to a stop before reaching the obstruction 14 by operating the brakes, particularly when the vehicle speed is low to begin with or the like.

In the next step 78, the control unit 44 determines whether collision with the obstruction 14 can be circumvented by operating the brakes. When an affirmative determination is returned in step 78, the processing returns to step 70. Also, when a negative determination is returned in step 78, the processing transitions to step 80, and in step 80 the control unit 44 compares the magnitude relation of the height H of the obstruction 14 with a maximum value Hmax of the minimum ground clearance that can be realized by the air suspension device 50, and the flow branches in accordance with the results of the comparison. It should be noted that the maximum value Hmax of the minimum ground clearance that can be realized by the air suspension device 50 is an example of a predetermined value in the present disclosure.

When the height H of the obstruction 14 is less than the maximum value Hmax of the minimum ground clearance, the processing transitions from step 80 to step 82. In step 82, the control unit 44 controls the operations of the air suspension device 50 such that the vehicle body height on a front wheel side of the vehicle is raised to the maximum vehicle body height that the air suspension device 50 can realize. Also, in step 84, the control unit 44 controls the operations of the air suspension device 50 such that the vehicle body height on a rear wheel side of the vehicle is raised to the maximum vehicle body height that the air suspension device 50 can realize. Also, in step 86, the control unit 44 controls the drive control ECU 60 so as to increase drive torque that is applied to the rear wheels of the vehicle 10 by the MGs 62, and then returns to step 70.

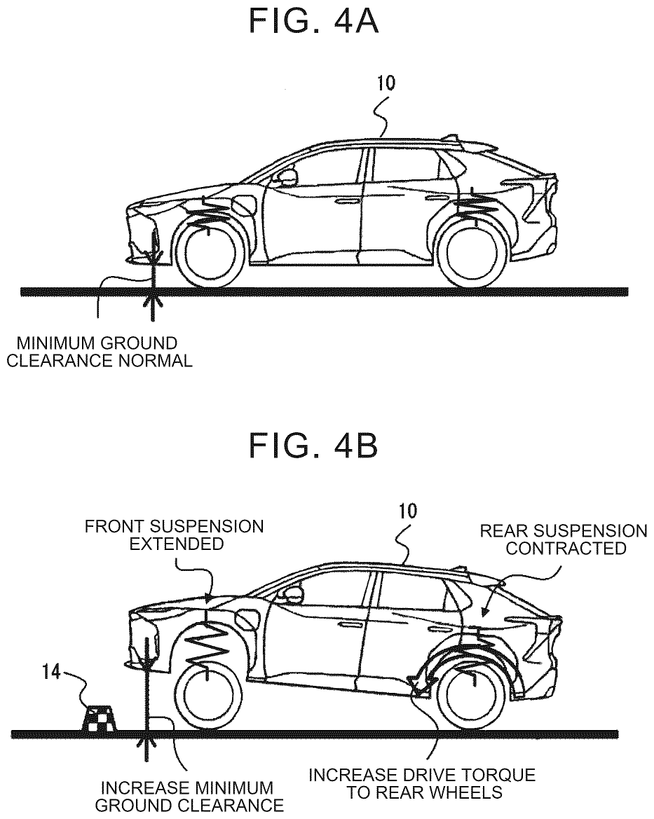

As a result of the processing of steps 82 to 86 that is described above, the vehicle body of the vehicle 10 changes from a steady state illustrated in FIG. 4A to a rearward-tilted attitude in which a side of the vehicle in a direction of travel is higher than a side opposite the direction of travel, as illustrated in FIG. 4B, and also in which state the minimum ground clearance at the front end portion of the vehicle body also increases. Accordingly, when the obstruction 14 passes through space downward from the vehicle body, the obstruction 14 can be circumvented from coming into contact with the battery 12.

Also, when the height H of the obstruction 14 is equal to or greater than the maximum value Hmax of the minimum ground clearance, there is a likelihood that the obstruction 14 will come into contact with the battery 12 even when the vehicle body of the vehicle 10 is adjusted to the minimum ground clearance and the attitude illustrated in FIG. 4B. Accordingly, when the height H of the obstruction 14 is equal to or greater than the maximum value Hmax of the minimum ground clearance, the processing transitions from step 80 to step 88.

In step 88, the control unit 44 controls the operations of the air suspension device 50 such that the vehicle body height on the front wheel side of the vehicle is lowered to the minimum vehicle body height that the air suspension device 50 can realize. Also, in step 90, the control unit 44 controls the operations of the air suspension device 50 such that the vehicle body height on the rear wheel side of the vehicle is raised to the maximum vehicle body height that the air suspension device 50 can realize. Further, in step 92, the control unit 44 controls the brake control ECU 64 so as to increase the braking torque that is applied to the front wheels of the vehicle 10 by the brake device 66, and then returns to step 70.

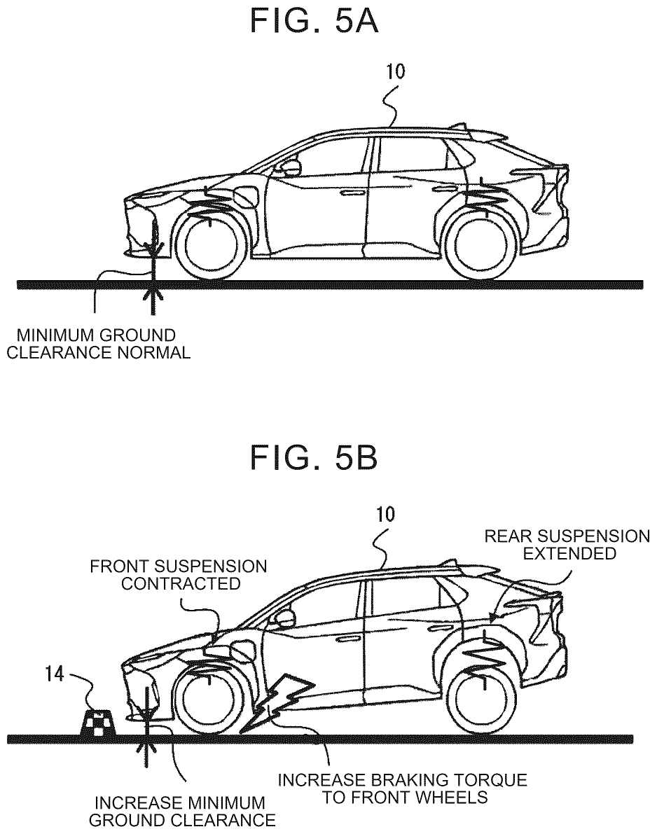

As a result of the processing of steps 88 to 92 that is described above, the vehicle body of the vehicle 10 changes from the steady state that is illustrated in FIG. 5A to a forward-tilting attitude in which the side of the vehicle in the direction of travel is lower than the side opposite the direction of travel, as illustrated in FIG. 5B, and also in which state the minimum ground clearance at the front end portion of the vehicle body also decreases. Accordingly, a situation in which the obstruction 14 enters the space downward from the vehicle body and comes into contact with the battery 12 can be circumvented, by the obstruction 14 colliding with the front bumper or the like that is located at the front end portion of the vehicle body.

As described above, in the present embodiment, the battery protection device 20 includes the LiDAR device 22 or the camera 24 that detects an obstruction 14 that is present in the direction of travel of the vehicle 10 that is provided with the battery 12 that is disposed downward from the floor of the vehicle body, and the air suspension device 50 that allows the vehicle body height to be adjusted. Upon determining that an obstruction 14 that is detected by the LiDAR device 22 or the camera 24 that will likely come into contact with the battery 12, the control unit 44 controls the air suspension device 50 and also controls the MGs 62 or the brake device 66 of the vehicle 10 to adjust the minimum ground clearance and the attitude of the vehicle body. Thus, adjusting the minimum ground clearance and attitude of the vehicle body enables contact of obstructions 14 with the battery 12 to be suppressed, and since there is no more need to provide protective materials or the like around the battery 12 to protect the battery 12, increase in the number of parts in the vehicle 10 can be suppressed.

Also, in the present embodiment, when detecting an obstruction 14 that is present in the direction of travel of the vehicle 10, the LiDAR device 22 or the camera 24 detects the height H of the obstruction 14. When the height H of the obstruction 14 that is detected by the LiDAR device 22 or the camera 24 is equal to or greater than the current minimum ground clearance of the vehicle body, the control unit 44 determines that there is a likelihood of the obstruction 14 coming into contact with the battery 12. Accordingly, whether there is a possibility that the obstruction 14 will come into contact with the battery 12 can be accurately determined.

Also, in the present embodiment, when the height H of the obstruction 14 detected by the LiDAR device 22 or the camera 24 is less than a predetermined value, the control unit 44 controls the air suspension device 50 so as to increase the minimum ground clearance on the front wheel side and the rear wheel side of the vehicle 10, respectively, and also increases the driving torque that the MGs 62 apply to the rear wheels of the vehicle 10. This causes the vehicle body of the vehicle 10 to assume a rearward-tilted attitude in which the side of the vehicle 10 in the direction of travel is higher than the opposite side of the direction of travel, thereby enabling circumvention of a situation in which the obstruction 14 with a height H of less than the predetermined value comes into contact with the battery 12 when the obstruction 14 passes through the space downward from the body.

Also, in the present embodiment, when the height of the obstruction 14 that is detected by the LiDAR device 22 or the camera 24 is equal to or greater than the predetermined value, the control unit 44 controls the air suspension device 50 such that the minimum ground clearance on the front wheel side of the vehicle 10 decreases and also the minimum ground clearance on the rear wheel side of the vehicle 10 increases, and also increases the braking torque that is applied by the brake device 66 to the front wheels of the vehicle 10. As a result, the vehicle body of the vehicle 10 assumes a forward-tilted attitude with the side of the vehicle 10 in the direction of travel lower than the opposite side of the direction of travel, and an obstruction 14 with a height H equal to or greater than the predetermined value collides with the front bumper or the like that is located at the front end portion of the vehicle 10 in the direction of travel, thereby enabling circumvention of a situation in which the obstruction 14 enters the space downward from the vehicle body and comes into contact with the battery 12.

Note that in the above embodiment, a case has been described in which the direction of travel of the vehicle 10 is a forward direction. However, in the present disclosure, the direction of travel of the vehicle 10 may be a reverse direction. When the direction of travel of the vehicle 10 is the reverse direction and an obstruction 14 is detected in the reverse direction of the vehicle 10, and the height H of the obstruction 14 that is detected is less than the maximum value Hmax of the minimum ground clearance that can be realized by the air suspension device 50, the minimum ground clearances on the front wheel side and the rear wheel side of the vehicle 10 are each increased, and also the vehicle body is controlled to assume a forward-tilting attitude. Also, when the direction of travel of the vehicle 10 is the reverse direction and an obstruction 14 is detected in the reverse direction of the vehicle 10, and the height H of the obstruction 14 that is detected is equal to or greater than the maximum value Hmax of the minimum ground clearance that can be realized by the air suspension device 50, the minimum ground clearance on the front wheel side of the vehicle 10 is increased, the minimum ground clearance on the rear wheel side of the vehicle 10 is decreased, and also the vehicle body is controlled to assume a rearward-tilted attitude. This enables a situation in which the obstruction 14 comes into contact with the battery 12 to be suppressed, even when the direction of travel of the vehicle 10 is the reverse direction.

Also, in the above embodiment, the air suspension device 50 that is capable of independently adjusting the vehicle body height of each of the four wheels has been described as an example of an active suspension device that is capable of adjusting the vehicle body height, but the present disclosure is not limited to this. The active suspension device that is capable of adjusting the vehicle body height may be configured to control, for example, two front wheels and two rear wheels simultaneously.

Further, in the above embodiment, a form in which an air suspension is applied has been described as an example of the active suspension device that is capable of adjusting the vehicle body height, but the present disclosure is not limited to this. The active suspension device that is capable of adjusting the vehicle body height may be, for example, an active suspension device or the like that is configured to operate under hydraulic pressure that is supplied from a hydraulic pressure source.

Furthermore, in the above embodiment, an example of the predetermined value in the present disclosure has been described by way of a form in which the maximum value Hmax of the minimum ground clearance that the air suspension device 50 can realize is applied, but the predetermined value in the present disclosure may be a value that is smaller than the maximum value Hmax.

Also, while a form has been described above in which the attitude and vehicle body height control program 42 is stored (installed) in the storage 36 in advance, the attitude and vehicle body height control program 42 can also be provided in a form of being recorded in a non-transitory recording medium such as a hard disk drive (HDD), a solid state drive (SSD), a digital versatile disc (DVD), or the like.

What is claimed is:

1. A vehicle battery protection device comprising:
a detecting unit that detects an obstruction that is present in a direction of travel of a vehicle that includes a battery that is disposed downward from a floor of a vehicle body and an active suspension device that is configured to adjust a vehicle body height; and
a control unit that, when determination is made that the obstruction that is detected by the detecting unit is likely to come into contact with the battery, controls the active suspension device and also controls a drive device or a braking device of the vehicle to adjust a minimum ground clearance and an attitude of the vehicle body.

2. The vehicle battery protection device according to claim 1, wherein
the detecting unit detects a height of an obstruction, when the obstruction that is present in the direction of travel of the vehicle is detected; and
the control unit determines that the obstruction is likely to come into contact with the battery, when the height of the obstruction that is detected by the detecting unit is equal to or greater than a current minimum ground clearance of the vehicle body.

3. The vehicle battery protection device according to claim 2, wherein, when the height of the obstruction that is detected by the detecting unit is less than a predetermined value, the control unit controls the active suspension device to increase the minimum ground clearance on each of a front wheel side and a rear wheel side of the vehicle, and also to increase drive torque that is applied by the drive device to rear wheels of the vehicle.

4. The vehicle battery protection device according to claim 2, wherein, when the height of the obstruction that is detected by the detecting unit is equal to or greater than a predetermined value, the control unit controls the active suspension device to decrease the minimum ground clearance on a front wheel side of the vehicle and also to increase the minimum ground clearance on a rear wheel side of the vehicle, and also increases braking torque that is applied by the braking device to front wheels of the vehicle.
